(19) United States
(12) Patent Application Publication
(10) Pub. No.: US 2022/0006640 A1
(43) Pub. Date: Jan. 6, 2022

(54) BLOCKCHAIN WITH NON-TURING COMPLETE SYSTEM GUARDS

(71) Applicant: Velo Holdings Limited, London (GB)

(72) Inventors: Justin Paul Handville, Largo, FL (US); Jacob Bowyer, London (GB)

(73) Assignee: Velo Holdings Limited, London (GB)

(21) Appl. No.: 17/292,707

(22) PCT Filed: Nov. 7, 2019
(86) PCT No.: PCT/IB2019/001200

§ 371 Date: May 10, 2021

Related U.S. Application Data
(60) Provisional application No. 62/758,141, filed on Nov. 9, 2018.

(51) Int. Cl. H04L 9/32; H04L 29/08; G06F 21/51

(52) U.S. Cl. CPC H04L 9/3239; H04L 9/3297; H04L 2209/38; H04L 67/26; G06F 21/51; H04L 67/025

(57) ABSTRACT

A system manages blockchain transactions through the use of guards and sentinels. Guards process data prior to the data's commitment to the blockchain by enforcing schema and access controls. Guards also send invalidation messages when a change to the blockchain invalidates a sentinel's view of what is true about the blockchain. Sentinels provide an interface to the blockchain for users and applications to develop data and queries to the blockchain, via in some embodiments, an application program interface. Sentinels also receive invalidation messages and take steps to determine the new state of the blockchain and take any additional actions responsive to the change. These actions may include complex responses involving, in some cases, addition of new blocks to the blockchain. Data additions proposed by a sentinel are still checked by the guards for conformance to establish rules and access controls.

### CROSS-REFERENCE TO RELATED APPLICATIONS

This application claims priority to and the benefit of Provisional Patent Application No. 62/758,141, filed Nov. 09, 2018, entitled “BLOCKCHAIN WITH NON-TURING COMPLETE SYSTEM GUARDS,” the entire contents of which are incorporated herein by reference.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Blockchain-based systems use a ledger to store successive transactions in elements known as blocks that are cryptographically signed to ensure the integrity of the ledger. However, many blockchain implementations have poor access security limiting the usefulness of the ledger. Further, many blockchain implementations have no provision for acting on transactions stored in the ledger. A so-called Turing complete system provides too many opportunities for failure and error.

### SUMMARY

A blockchain system in accordance with the current disclosure uses an interpreted system to provide a layered approach to blockchain-based transactions. The system allows strict controls on the addition of blocks to a blockchain using guards. The guards validate authors, data, requests, and block schema in a rigid structure that prohibits invalid data from being added to the blockchain while also ensuring that the processes operating on the transaction creation are deterministic and strictly terminating. The guards are also idem potent, meaning that multiple executions of the same transaction will always return the same result, the opposite of which is a common failure in many blockchain implementations.

Post-commit activity may be supported by sentinels that respond to changes in condition occurring both internally and externally to the blockchain. The sentinels may use an application programming interface (API) to allow programmers to interact with the blockchain using any language but within the limits set by the guards for data access and new block creation.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 is a block diagram of a system implementing guards and sentinels for blockchain management;

FIG. 2 is a sequence diagram of interactions associated with blockchain management in accordance with the current disclosure; and

FIG. 3 is a sequence diagram illustrating aggressive invalidation with lazy re-evaluation.

### DETAILED DESCRIPTION

Blockchain is being used for everything from private currency to tracking vegetable shipments. However, the real test of blockchain implementation is in bank and corporation financial transactions. These entities require the ability to ensure the end-to-end integrity of complex transactions and have not been able to use blockchain-based “smart contracts” because they are neither secure enough to meet their standards nor do they have the flexibility to evolve with changing regulations and company operating policies. The needs of, for example, large banks include the ability to control access to each artifact of data in any block and the configurability of each block.

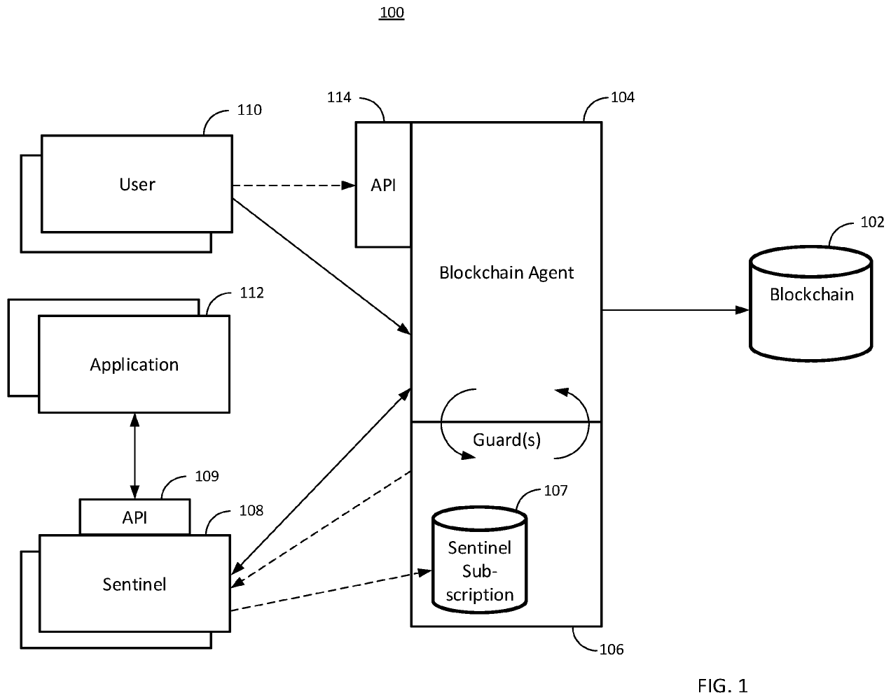

A system 100 in accordance with the current disclosure solves these problems with a secure and robust architecture and the use of guards and sentinels. FIG. 1 is a block diagram of components 100 that may be present in such a high integrity blockchain environment. The diagram focuses on one user/application/sentinel for clarity, but in operation the system 100 may include dozens or more participants who are associated with the contributing or consuming data stored in a blockchain 102.

The blockchain 102 is the storage facility for data associated with transactions and events associated with the topic being managed. As mentioned above, the blockchain 102 may be applicable to currency, shipments, production, as well as financial and financially-related transactions. The blockchain agent 104 is the control for creating blocks in the blockchain 102 and for extracting data from those blocks. The agent 104 includes the necessary cryptographic processing functions to perform the signature processes that bind a block to the chain as well as any encryption processing used to enforce access control to various aspects of individual blocks and the blockchain 102 itself. A guard 106 is used to perform integrity checks and other pre-commit processing of data being added to the blockchain 102 as well as provide notifications of changes. A sentinel subscription database 107 may be under the guard 106 or the blockchain agent 104. The guards 106 and sentinel subscription database are discussed in more detail below.

A sentinel 108 acts on behalf of one or more users 110 to access data in the blockchain 102 and to allow the users 110 to programmatically make changes to the blockchain 102. The sentinel 108 may run in an interpreted environment supporting an application programming interface 109 (API) that allows the users 110 to program complex interactions with the blockchain 102 via an application 112. The application 112 may be written in the language of the user's choice, such as C++, Java, etc.

The sentinel 108 may operate using a construct designated as aggressive invalidation/lazy re-evaluation in order to manage database coherency with respect to blockchain assertions and invalidations. Rather than attempting to keep all parties that use the blockchain data in lockstep with every change, each sentinel 108 in the system 100 may maintain its view of the blockchain 102 or artifacts associated with the blockchain 102. When the blockchain 102 changes, the guard 106 may send an invalidation notice to the sentinel 108 indicating that what the sentinel 108 believes to be true is no longer valid. The sentinel 108 immediately knows that its view is invalid and may take steps in its own time to re-establish its local view of the current state of the blockchain.

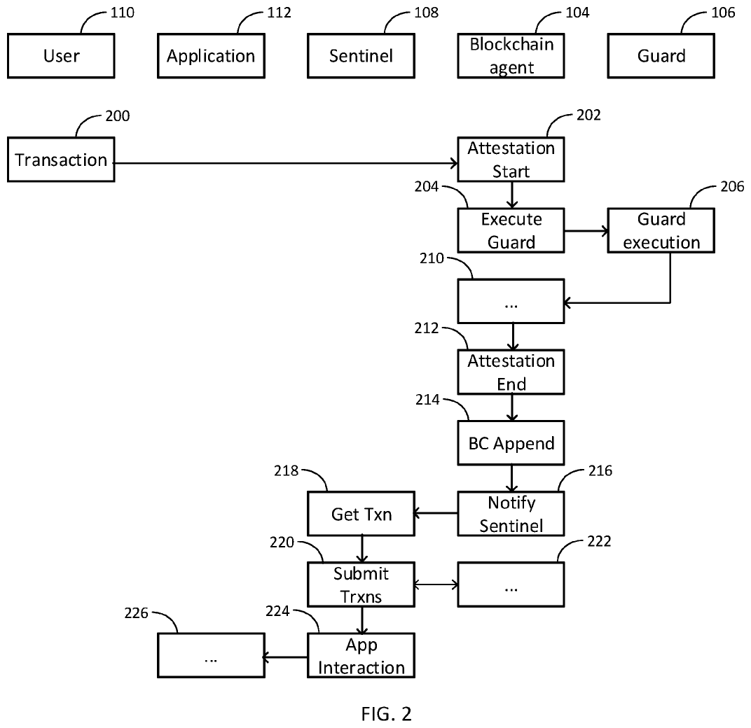

Turning to FIG. 2, a sequence diagram may illustrate one example of interactions among system components. In this example, the blockchain 102 may be used to store personnel information for a company. When the company adds a new employee, a user, etc., a personnel manager may generate a transaction 200 to add the new employee to the blockchain 102. In this illustration, the request is made directly to the blockchain agent 104. In other embodiments, the request may be made through an application 112 that interacts with a sentinel 108 via the API 109 of the sentinel 108.

Attestation, or the process of adding a block to the blockchain 102, may begin at block 202, being executed by the blockchain agent 104. The blockchain agent 104 may activate a guard 106 at block 204, so that the guard 106 at block 206 can perform the processing checks associated with all blocks in general of the blockchain 102 or for specific requests for changes to the blockchain 102. The guard 106 may accept the request/data, reject the request/data, or throw an error indicating a problem with, for example, the request itself, the data in the request, the requestor, or another problem.

When the guard 106 approves the transaction, the blockchain agent 104, at block 210 may receive the status response from the guard 106 and, assuming approval, the attestation is completed at block 212, followed by the addition of the block to the blockchain at block 214. At block 216, the blockchain agent 104, or in some embodiments, the guard 106 may notify the sentinel 108 that its view of the blockchain 102 is invalid with respect to employee-related artifacts. The sentinel 108, at block 218, may receive the invalidation and in response suspend operations related to employees, query the blockchain for current information and then take the appropriate action, in this case, creating a transaction to update the sentinel's data at block 220. For example, a blockchain transaction to query the blockchain 102 for current employee data may be entered at block 222 while the new employee data may be sent at block 224 to an application 226 that sends the new employee data to an external payroll processor.

The request transaction entered at block 222 would follow the same guard-checking process as described above, so that even though the sentinel 108 made the request and may have a higher level of trust than the user 110, the guard 106 will still make the appropriate checks for completeness, consistency, and authorization.

In general, the guard 106 or guards, enforce integrity precommit, that is, prior to commitment of blocks to the blockchain. These may include:
Schema: That the block is consistent with the specification
Correctness: The data is accurate and can serve as the point of truth
Permissioning: Who is allowed to see what artifacts in the block and what actions are they allowed to perform—both based on the permissions assigned to them/their role as well as managing the lifecycle of the artifacts on the blockchain 102.
Enforcement: Constraining sentinels and ensuring adherence to established rules or compliance requirements.

In addition, the guards 106 provide notifications of changes to the blockchain 102 including:
Aggressive Invalidation: Notifying sentinels of changes to the blockchain 102 that invalidate a sentinel's understanding of the state of the blockchain 102.

As discussed above, sentinels 108 enable complex transaction orchestration and handling while adhering to rules established by guards 106. These may include:
Orchestration: intelligence for the sequencing and handling of complex transactions.
Traceability: generation of signed transactions linked to the identity of the Sentinel and the identity of the requesting service/party.
Implementation Simplicity: a sentinel 108 is effectively an API, and can be written in any programming language, providing blockchain users with the flexibility to leverage the languages and expertise they have in-house since sentinels can be written in any language, institutions' existing Java developers can now all be blockchain developers.
Secure Extensibility: Banks and Corporates can deploy applications on the blockchain 102 and ensure security and compliance with the invocation of one or more guards 106; Users can apply their existing design practices, security standards, and design rules/patterns as a pre-commit trigger for the blockchain to ensure integrity before a transaction is written to the block. For example, a guard may determine whether an entity is allowed to create the transaction or whether specific content is allowed.
Lazy re-evaluation: responsive to an invalidation from a guard, the sentinel 108 may act on changes to the blockchain 102 in a manner appropriate to the data change. That is, some changes may require a fast, active response while other changes may be responded to in a more leisurely fashion.

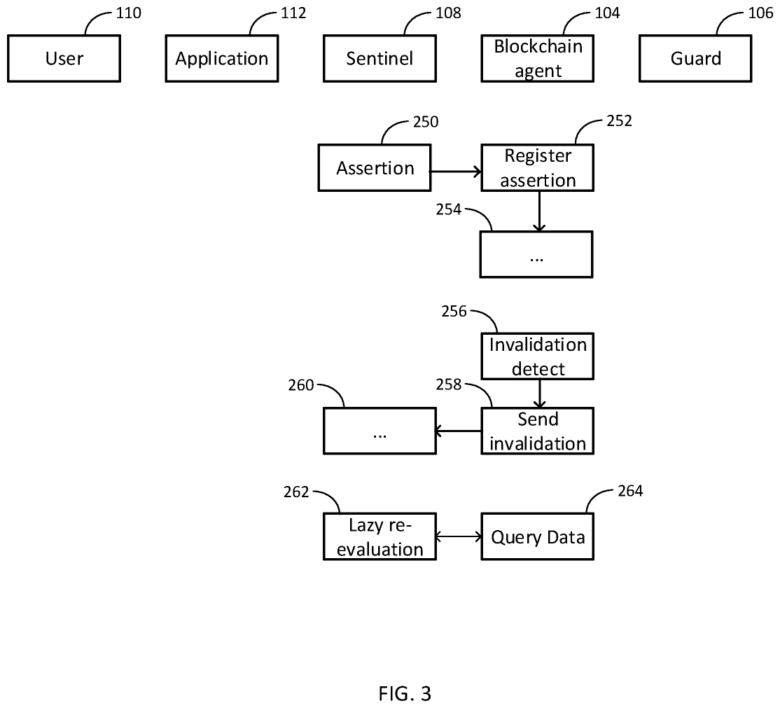

FIG. 3 illustrates a summary of the aggressive invalidation—lazy re-evaluation process. At block 250, a sentinel 108 may make an assertion to the blockchain agent 104 and contingent on meeting the provisions of the guard 106, a block may be added to the blockchain 102 at block 254. Subsequently, at block 256, a change may be made to the blockchain 102 that invalidates the view of the blockchain at the sentinel 108. For example, an artifact may be updated, such as a name change. The blockchain agent 104 or guard 106 may send an invalidation at block 258. At block 260, the sentinel 108 may note that its view of the blockchain 102 is no longer valid. At its leisure, at block 262, the sentinel 108 may submit a query to the blockchain agent 104 to determine the updates to the blockchain 102 and take appropriate action based on the changes.

The aggressive invalidation—lazy re-evaluation provides several performance benefits including reduced network chatter. An invalidation can be sent to all sentinels at once, eliminating the need for separate messages to each sentinel. In other embodiments, a replication strategy may be used to de-duplicate streaming data to all local nodes.

The Sentinel API may use an aggressive invalidation/lazy re-evaluation scheme. The application 112, or a sentinel 108 representing a client can subscribe to block level, artifact level, or transaction level updates. In each case, the sentinel application asserts to the API that the relevant state at the block, artifact, or transaction level is the latest state. Either immediately, or at some point in the future, the API will respond with an invalidation of this assertion. At this point, the sentinel application can, at its discretion, retrieve the latest records. This scheme provides two very important features. First, the application is free to store the state under which it is asserting for invalidation under a local database transaction, so that the lazy re-evaluation scheme is completely transactional to the application. In this way, a sentinel application is free to consume the data from the blockchain using its own local database transactional strategy.

Second, the blockchain service itself only needs to track, maintain, and update just enough information to invalidate the sentinel's assertion, which significantly improves scalability and responsiveness. Invalidations are very small messages, and re-evaluation does not need to occur in real time for the sentinel API to be effective. Furthermore, re-evaluation can be distributed across the blockchain or restricted to a local copy of the blockchain, which can significantly reduce chatter when many sentinel applications need to interact with the blockchain. As for making changes to the blockchain, the sentinel itself must submit transactions as any other user of the blockchain does. These transactions are subject to guards, thus ensuring that even though the sentinels can be written in any language, data integrity rules on the blockchain are enforced by the guards.

A sentinel subscription database 107 may be operated by the guard 107 and/or blockchain agent 104. The database 107 may include schema that store subscription information for each sentinel 108. As changes to the blockchain 102 are made, the database 107 may be consulted to determine which sentinels 108 are affected by that change. The guard 107 may then send the appropriate invalidation message or messages. The sentinels 108 may make updates to the database 107 on behalf of users 110 or applications 112, for example, via the API 109.

Examples of the types of invalidations that may be subscribed include:
block level, e.g., block #899172 is the latest block
artifact type level e.g., transaction Z is the latest transaction against all artifacts of type M
artifact level, e.g., transaction X is the latest transaction for artifact Y
transaction type level, e.g., transaction Y is the latest transaction of type PAYMENT
transaction level, e.g., transaction W is the latest transaction in the blockchain

The sentinel API 109 supports various functions, including but not limited to live blockchain backup and replication. A block-level sentinel reads and verifies each block. As each block is verified, the block is stored locally. When the latest block has been read, the sentinel 108 makes a block-level assertion that the last block it read is the latest block in the blockchain 102. At some point in the future, this assertion will be invalidated, and the sentinel 108 begins reading the next blocks at its leisure.

Alternatively, this sentinel could itself run as a blockchain agent, providing a sentinel API so that the replicated blockchain can be used for downstream sentinels while only requiring a single update stream from the upstream blockchain.

In addition, a so-called “materialized view” of the blockchain 102 is supported including an application-specific view of data from the blockchain 102 that may be maintained via the sentinel API 109. This view allows legacy applications to interact with the blockchain 102 using a traditional RDBMS where the sentinel 108 maintains the view with respect to the blockchain 102.

An artifact type sentinel 108 subscribes to any transactions relating to the payment artifact type. This sentinel 108 starts by asserting that there have never been any transactions against this artifact type. At some point in the future, or perhaps immediately, this assertion is invalidated by the blockchain 102. The sentinel 108 begins querying all transactions related to the payment artifact type, starting with the block that invalidated this assertion.

The sentinel may process payments using its local database and submit transactions back to the blockchain to progress the state of these payments. Eventually, all payments are processed, and the sentinel application can commit these changes to its local database. The sentinel application can then assert that the last payment transaction it saw, according to its local database, is the latest transaction associated with the payment artifact type. Eventually, this assertion is invalidated, and the sentinel queries for new transactions starting at the invalidating block.

“Smart contracts” suffer from various serious problems arising from their underlying computational architecture. In short, Turing complete smart contracts are flawed. A system in accordance with the current disclosure addresses these flaws by constraining the system using the guards 106.

The blockchain guards 106 are finite, idempotent, strictly terminating, and completely deterministic.
The guards 106 can be represented as a basic stack machine in which query state is managed by an oracle, and in which execution can only move forward, with the following caveats:
It is possible to call specially crafted “functions” in this machine, which halts execution of this machine and starts execution in a separate machine context with a shared stack.
The “function” exists entirely within this machine and cannot reference the execution of the previous machine or itself, except:
In either a corecursive (referencing previous machine) or recursive manner, a recursion value is provided which must be structurally or numerically reduced toward empty/zero in order to prove termination. For example, an exemplary recursion may include a finite count and that count must progress to zero.
These caveats allow building logical proofs that reason about the execution of a given set of guards, or of any arbitrary guard in the stack machine, thus demonstrating that the machine is sound for any arbitrary guard.
Intrinsics are provided to allow guards to evaluate the current transactional state (i.e. data) of the blockchain and to import this data into the stack machine for deeper inspection.

### Blockchain Sentinels

Sentinel 108 features:
“post-commit” trigger for blockchain transactions, allowing custom code to execute. The sentinels act as choreographers and listeners in that the sentinel can listen for events both internal and external to the blockchain and then take an appropriate action based on such a trigger event.
Guards 106 provide a constrained way to enforce the integrity of data.
Sentinels 108 provide a safe way for arbitrary software, written using a language and platform of the users choosing, to participate in blockchain transaction management in a way that is complementary to blockchain guards 106.
Guards 106 constrain the actions of sentinels 108 as well as other users.
Sentinels 108 react to events on the blockchain 102 in order to choreograph more complex transactional behaviors.
Sentinels 108 provide a safe way for the blockchain to react to external events and behaviors, including but not limited to random events, time-based events, and integrations with external systems.
Actions of a sentinel 108 are audited by the system as if they were performed by any other entity. They may create new transactions in the blockchain 102, signed by their keys, because they are entities.
This division between sentinels 108 and guards 102 is significantly safer and easier to reason about with respect to security than so-called “smart contracts.”

A technical effect of the system and methods described is a blockchain system that uses guards to protect data integrity and provide aggressive invalidation in addition to sentinels that provide for updates to the blockchain as well as act on changes. The invalidation/re-evaluation technique disclosed has the technical benefit of reducing network traffic and eliminating the need to perform real time synchronization of changes to the blockchain with each consumer of the blockchain data.

A system in accordance with the disclosure benefits both users of the blockchain and the blockchain system operator. Users may develop applications and sentinels in the language of their choice and using both the blockchain API and the sentinel API to access the system. The aggressive invalidation allows sentinel owner/operators to respond in the manner and time as appropriate to each application.

The system and methods described benefit both users and system owners. Users are provided with a simple, convenient API via a sentinel 108 with which to interact with a blockchain record system. System owners are able to guarantee, through the use of guards 106, that data, access control, and compliance regulations are met for each and every transaction placed on the blockchain 102.

We claim:

1. A method of performing transactions implemented in a blockchain, the method comprising:
receiving a request to add a block to the blockchain at a blockchain agent;
activating a guard that processes the request pre-commit;
screening, via the guard, the request for compliance to integrity and security rules;
responsive to successful screening by the guard, writing a new block to the blockchain via the blockchain agent.

2. The method of claim 1, further comprising:
determining a change to the blockchain has been made;
sending an invalidation message to at least one sentinel, the at least one sentinel associated with a participant in the blockchain;
sending, via the sentinel, a query to the blockchain to determine the change;
receiving, via the sentinel, a response to the query;
generating an action based on the response to the query.

3. The method of claim 2, wherein screening, via the guard, the request for compliance to integrity and security rules comprises determining that the block is consistent with the specification for the blockchain.

4. The method of claim 2, wherein screening, via the guard, the request for compliance to integrity and security rules comprises determining that the data in the block is accurate.

5. The method of claim 2, wherein screening, via the guard, the request for compliance to integrity and security rules comprises determining that the data in the block serves as a point of truth.

6. The method of claim 2, wherein screening, via the guard, the request for compliance to integrity and security rules comprises determining that the requestor has permission to take the action requested.

7. The method of claim 6, wherein screening, via the guard, the request for compliance to integrity and security rules comprises determining that the requestor has permission to access the requested artifact.

8. The method of claim 2, wherein the sentinel subscribes to an artifact-based invalidation.

9. The method of claim 8, wherein the artifact-based invalidation is a block level invalidation indicating a latest block identifier.

10. The method of claim 8, wherein the artifact-based invalidation is an artifact type level-based invalidation.

11. The method of claim 8, wherein the artifact-based invalidation is an artifact-based invalidation.

12. The method of claim 8, wherein the artifact-based invalidation is a transaction type level invalidation.

13. The method of claim 8, wherein the artifact-based invalidation transaction level-based invalidation.

14. A system that improves performance in an blockchain data ledger system, the system comprising:
a blockchain agent that interacts with the blockchain data;
a plurality of sentinel modules that perform actions on behalf of applications and users external to the system;
a guard module coupled to the blockchain agent that validates transactions prior to submission to the blockchain agent, the guard further monitoring changes to the blockchain data;
a sentinel subscription database accessible to the sentinel module and the guard module, the sentinel subscription database storing a list of artifacts and corresponding sentinel modules from the plurality of sentinel modules, wherein the guard module monitors changes to an artifact, consults the sentinel subscription database, and notifies a corresponding one or more sentinel modules of the change to the artifact.

15. The system of claim 14, wherein the corresponding one or more sentinel modules receive the notification of the change to the artifact from the guard, and perform a query to the blockchain agent to determine the change to the artifact.

16. The system of claim 15, wherein receiving the notification of the change to the artifact at the one or more sentinel modules and performing the query to the blockchain agent are asynchronous.

17. The system of claim 14, wherein a sentinel module of the plurality of sentinel modules supports an application program interface that supports communication between an application external to the system and corresponding single sentinel module.
